(19) United States
(12) Patent Application Publication
(10) Pub. No.: US 2008/0317047 A1
(43) Pub. Date: Dec. 25, 2008

(54) METHOD FOR DISCOVERING A ROUTE TO A PEER NODE IN A MULTI-HOP WIRELESS MESH NETWORK

(75) Inventors: Surong Zeng, Schaumburg, IL (US); Charles R. Barker, JR., Orlando, FL (US); Keith J. Goldberg, Casselberry, FL (US); Shyamal Ramachandran, Heathrow, FL (US); Guenael T. Strutt, Sanford, FL (US); Sebnem Zorlu Ozer, North Wales, PA (US)

Correspondence Address: MOTOROLA, INC, 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/765,704

(22) Filed: Jun. 20, 2007

(51) Int. Cl. H04L 12/56; H04J 3/24; H04N 11/20; H04Q 7/24

(52) U.S. Cl. 370/401; 370/338; 370/349

(57) ABSTRACT

A method is provided for a particular multi-radio meshed node to discover a route to a peer multi-radio meshed node in a wireless multi-hop network including a plurality of multi-radio meshed nodes. Each of the multi-radio meshed nodes each includes a plurality of radio modules, and each radio module comprises an interface. The particular multi-radio meshed node transmits route request (RREQ) messages from each interface of a particular multi-radio meshed node. When a particular recipient multi-radio meshed node receives at least one of the route request (RREQ) messages, it generates a reverse route to the particular multi-radio meshed node. A peer-to-peer route is established when the particular multi-radio meshed node receives a route reply (RREP) message and can then be used to forward traffic to and from the destination node.

### FIELD OF THE INVENTION

The present invention relates generally to multi-hop communication networks, and in particular to routing within a multi-hop communication network.

### BACKGROUND

An infrastructure-based wireless network typically includes a communication network with fixed and wired gateways. Many infrastructure-based wireless networks employ a mobile unit or host which communicates with a fixed base station that is coupled to a wired network. The mobile unit can move geographically while it is communicating over a wireless link to the base station. When the mobile unit moves out of range of one base station, it may connect or “handover” to a new base station and starts communicating with the wired network through the new base station.

In comparison to infrastructure-based wireless networks, such as cellular networks or satellite networks, ad hoc networks are self-forming networks which can operate in the absence of any fixed infrastructure, and in some cases the ad hoc network is formed entirely of mobile nodes. An ad hoc network typically includes a number of geographically-distributed, potentially mobile units, sometimes referred to as “nodes,” which are wirelessly connected to each other by one or more links (e.g., radio frequency communication channels). The nodes can communicate with each other over a wireless media without the support of an infrastructure-based or wired network. Links or connections between these nodes can change dynamically in an arbitrary manner as existing nodes move within the ad hoc network, as new nodes join or enter the ad hoc network, or as existing nodes leave or exit the ad hoc network.

One characteristic of the nodes is that each node can directly communicate over a short range with nodes which are a single “hop” away. Such nodes are sometimes referred to as “neighbor nodes.” When a node transmits packets to a destination node and the nodes are separated by more than one hop (e.g., the distance between two nodes exceeds the radio transmission range of the nodes, or a physical barrier is present between the nodes), the packets can be relayed via intermediate nodes (“multi-hopping”) until the packets reach the destination node. In such situations, each intermediate node routes the packets (e.g., data and control information) to the next node along the route, until the packets reach their final destination. For relaying packets to the next node, each node maintains routing information collected through communication with neighboring nodes. The routing information can also be periodically broadcast in the network to reflect the current network topology. Alternatively, to reduce the amount of information transmitted for maintaining accurate routing information, the network nodes may exchange routing information only when it is needed. In an approach known as Mesh Scalable Routing (MSR), nodes periodically send HELLO messages (e.g., once per second) that contain routing and metrics information associated with the route to its bound intelligent access point (IAP), and discover certain peer routes on-demand. Traditionally a single node would have one radio module and one routing module which manages routing for that radio module.

A wireless mesh network is a collection of wireless nodes or devices organized in a decentralized manner to provide range extension by allowing nodes to be reached across multiple hops. In a multi-hop network, communication packets sent by a source node can be relayed through one or more intermediary nodes before reaching a destination node. A large network can be realized using intelligent access points (IAP) which provide wireless nodes with access to a wired backhaul.

Wireless ad hoc networks can include both routable (meshed) nodes and non-routable (non-meshed) nodes. Meshed or “routable” nodes are devices which may follow a standard wireless protocol such as Institute of Electrical and Electronics Engineers (IEEE) 802.11s or 802.16j. These devices are responsible for forwarding packets to/from the proxy devices which are associated with them. Non-meshed or “non-routable” nodes are devices following a standard wireless protocol such as IEEE 802.11a, b, e, g or IEEE 802.15 but not participating in any kind of routing. These devices are “proxied” by meshed devices which establish routes for them.

Recently, nodes have been designed to include chipsets for implementing multiple different radio modules (e.g., one radio module which complies with the IEEE 802.11(a) standard, another radio module which complies with the IEEE 802.11(g) standard, and possibly another radio module which complies with the IEEE 802.11(b) standard, etc.). Each radio module is typically implemented on its own chip and has its own physical (PHY) layer, its own medium access control (MAC) layer, and its own routing module which manages routing for that particular radio module. Each routing module is typically implemented above the MAC layer of its particular radio module.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating an example of a communication network;

FIG. 2 is an electronic block diagram illustrating one embodiment of a multi-radio meshed node or communication device;

FIG. 3 is a conceptual diagram which illustrates a multi-radio meshed node having multi-radio architecture for routing over a multi-radio platform in accordance with some embodiments of the present invention;

FIG. 4 is a three-dimensional diagram which illustrates a meshed node having a multi-radio architecture for routing over a multi-radio platform in accordance with some embodiments of the present invention;

FIG. 5 is a three-dimensional diagram which illustrates another meshed node having a multi-radio architecture for routing over a multi-radio platform in accordance with some embodiments of the present invention;

FIG. 6 is a three-dimensional diagram which illustrates another meshed node having a multi-radio architecture for routing over a multi-radio platform in accordance with some embodiments of the present invention;

FIG. 7 is a block diagram which illustrates the structure of an intelligent access point (IAP) priority list maintained by a routing manager module in accordance with some embodiments of the present invention;

FIG. 8 is a data structure which illustrates a format of a HELLO message in accordance with some embodiments of the present invention;

FIG. 9 is a flowchart illustrating a method for intelligent access point (IAP) route discovery to establish a route to an intelligent access point (IAP) when the IAP presents itself in a network in accordance with some embodiments of the present invention;

FIG. 10 is a data structure which illustrates a format of a route request (RREQ) message in accordance with some embodiments of the present invention;

FIG. 11 is a data structure which illustrates a format of a route reply (RREP) message in accordance with some embodiments of the present invention; and

FIG. 12 is a flowchart illustrating a method for peer-to-peer route discovery in accordance with some embodiments of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a multi-radio system which supports multi-radio routing. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one module or action from another module or action without necessarily requiring or implying any actual such relationship or order between such modules or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions for a multi-radio system which supports multi-radio routing described herein. The non-processor circuits may include, but are not limited to, a radio receiver, a radio transmitter, signal drivers, clock circuits, power source circuits, and user input devices. As such, these functions may be interpreted as steps of a method for use in a multi-radio system which supports multi-radio routing. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Terminology

Prior to describing some embodiments of the multi-radio methods and systems which support multi-radio routing, for purposes of convenience, some of the basic background terminology that is repeatedly referenced in the following description will be described.

As used herein, the term “ad hoc network” refers to a self-configuring network of nodes connected by wireless links, the union of which form an arbitrary topology.

As used herein, the term “meshed node” refers to a communication device which has “meshing capability” meaning that a node has routing functionality and can route traffic to and from other nodes with routing functionality. Examples of meshed nodes include a mesh point (MP), a Mesh Access Point (MAP), and an intelligent Access Point (IAP).

As used herein, the term “Access Point (AP)” refers to a device connected to a wired network that enables remote wireless nodes to communicate with the wired network (e.g. local area network (LAN), wide area network (WAN), etc.). An AP connects wireless communication devices which are in its direct communication range (i.e. one-hop away) together to form a wireless network. In many cases, the AP connects to a wired network, and can relay data between wireless devices and wired devices. In one implementation, an AP may comprise a Mesh Access Point (MAP) which has meshing capability. A MAP is distinguishable from a regular AP in that an MAP implements a mesh routing protocol such as a Mesh Scalable Routing (MSR) protocol disclosed in U.S. Pat. No. 7,061,925 B2, entitled “System and Method for Decreasing Latency in Locating Routes Between Nodes in a Wireless Communication Network” assigned to the assignee of the present invention, its contents being incorporated by reference in its entirety herein. An Intelligent Access Point (IAP) is a specific type of MAP which connects to a wide area wired network (WAN) and can relay data between the wireless devices and the wired devices on the WAN. IAPs and MAPs can enable communication between the wired network and remote wireless nodes which are multi-hop away through the MSR and its proxy routing variant as described in United States published patent application 20060098612, filed Sep. 7, 2005, entitled “System and method for associating different types of nodes with access point nodes in a wireless network to route data in the wireless network”, and United States published patent application 20060098611, filed Sep. 7, 2005, entitled “System and method for routing data between different types of nodes in a wireless network.”

As used herein, “IEEE 802.11” refers to a set of IEEE Wireless LAN (WLAN) standards that govern wireless networking transmission methods. IEEE 802.11 standards have been and are currently being developed by working group 11 of the IEEE LAN/MAN Standards Committee (IEEE 802). Any of the IEEE standards or specifications referred to herein may be obtained at http://standards.ieee.org/getieee802/index.html or by contacting the IEEE at IEEE, 445 Hoes Lane, PO Box 1331, Piscataway, N.J. 08855-1331, USA.

In an IEEE 802.11 wireless LAN (WLAN), the coverage of one Access Point (AP) is called a Basic Service Set (BSS). An AP acts as a master to control the stations (STAs) within that BSS. Each BSS is identified by a basic service set identifier (BSSID). In addition to BSSID, another SSID is used to identify an Extended Service Set (ESS), which uniquely identifies a group of wireless network devices used in a given “Service Set.” An AP broadcasts its SSID (“network name”) via packets that are called beacons. In infrastructure mode, groups of BSSs can be connected together with the use of a backbone network and form a network called an extended service set (ESS). Extended Service Set (ESS) refers to a set of one or more interconnected BSSs and integrated local area networks (LANs) that appear as a single network to the logical link control layer at any station associated with one of those BSSs.

As used herein, “IEEE 802.11s” refers to a set of IEEE draft standards currently being developed (i.e., unapproved at present) by IEEE under the title 802.11s. IEEE 802.11s defines an architecture and protocol for Extended Service Set (ESS) Mesh Networking. IEEE 802.11s specifies an extension of the original IEEE 802.11 Medium Access Control (MAC) layer to solve the interoperability problem by defining an architecture and protocol that support both broadcast/multicast and unicast delivery using “radio-aware metrics over self-configuring multi-hop topologies.” The protocol will provide auto-configuring paths between APs over configuring multi-hop topologies in a Wireless Distribution System (WDS) to support both broadcast/multicast and unicast traffic in an ESS Mesh. As used herein, the term “IEEE 802.11s WDS data frame format” refers to a data frame format used in a Wireless Distribution System (WDS) system proposed in a set of specifications which make up the IEEE 802.11s standard.

As used herein, the term “Wireless Distribution System (WDS)” refers to a system that enables the interconnection of access points wirelessly. WDS allows a wireless network to be expanded using multiple access points without the need for a wired backbone to link them as is traditionally required. Non-routable devices such as legacy station (LSTA) or QoS station (QSTA) can join the network through their associated access point. These access points are routable devices which provide proxying functionality for those non-routable devices, and are able to route the traffic generated by a non-routable device associated with it to the correct remote destination which can be a routable or non-routable device. As used herein, the term “Mesh Access Point (MAP)” refers to a routable AP which has mesh routing capability, such as those complying with the IEEE 802.11s standard, and is able to provide proxy functionality to non-routable devices associated with it.

As used herein the term “routing algorithm” or “routing protocol” refers to a protocol used by a routing module to determine the appropriate path over which data is transmitted. The routing protocol also specifies how nodes in a communication network share information with each other and report changes. The routing protocol enables a network to make dynamic adjustments to its conditions, so routing decisions do not have to be predetermined and static. A routing protocol controls how nodes come to agree which way to route packets between the nodes and other computing devices in a network. Any routing algorithm or protocol can be used in conjunction with the multi-radio system(s) described herein. There are hundreds (or more) of existing ad hoc routing protocols. Examples of some ad hoc routing protocols include, for example, protocols, such as, AODV routing protocol, Dynamic Source Routing (DSR) protocols, and Mesh Scalable Routing (MSR) protocol.

As used herein, the term “Ad hoc On-demand Distance Vector (AODV)” refers to a routing protocol for ad hoc mobile networks with large numbers of mobile nodes. The protocol's algorithm creates routes between nodes only when the routes are requested by the source nodes, giving the network the flexibility to allow nodes to enter and leave the network at will. Routes remain active only as long as data packets are traveling along the paths from the source to the destination. When the source stops sending packets, the path will time out and close. The AODV protocol is defined in RFC 3561 by C. Perkins, E. Belding-Royer, and S. Das, “Ad hoc On-Demand Distance Vector (AODV) Routing”, http://www.rfc-editor.org/rfc/rfc3561.txt. In the remainder of this document, routing will be explained with reference to Ad hoc On-demand Distance Vector (AODV) based routing protocols described in United States patent publication 20040143842, filed Jan. 13, 2004, entitled “System and method for achieving continuous connectivity to an access point or gateway in a wireless network following an on-demand routing protocol, and to perform smooth handoff of mobile terminals between fixed terminals in the network.” In this routing protocol, when a portal node, for example, an Intelligent Access Point (IAP), is present in the network, each node with meshing capability proactively maintains the route to the IAP and dynamically sets up at least one route to other peers when the routes are needed. In the description which follows, numerous references will be made to the AODV protocol (RFC 3561) for purposes of illustrating a routing protocol which can be used in one implementation of the disclosed embodiments; however, it will be appreciated by those skilled in the art that many other known routing protocols can be also utilized.

Overview

A multi-radio platform is provided in which multiple, different radio modules are implemented on single chip or “chipset.” For example, in one embodiment, the multi-radio platform comprises one radio module which complies with the IEEE 802.11(a) standard, another radio module which complies with the IEEE 802.11(g) standard, and possibly another radio module which complies with the IEEE 802.11(b) standard, etc. Each radio module comprises its own unique physical (PHY) layer and its own unique medium access control (MAC) layer. Each of the radio modules is capable of operating on at least one carrier frequency.

To improve the network capacity, it would be desirable to provide a multi-radio system which supports multi-radio routing, and to extend mesh routing to support the multi-radio platforms. To increase data throughput, it would be desirable if a single node could simultaneously communicate using more than one radio module or “radio interface” (e.g., receive information on one carrier frequency from one radio and transmit information on another carrier frequency to another radio). However, some mechanism would be required for managing these simultaneous communications over multiple different radio interfaces. In the context of a meshed network, for example, a mechanism would be required to perform routing functions among the different radio modules in the multi-radio meshed node.

In accordance with an embodiment of the present invention, a multi-radio meshed node is provided which comprises a single routing module that can perform routing functions for the different radio modules implemented in that multi-radio meshed node. In other words, the radio modules share a common control layer or “common routing module” which can be implemented above each of the MAC layers of these radio modules to manage routing among the different radio modules.

Communication Network

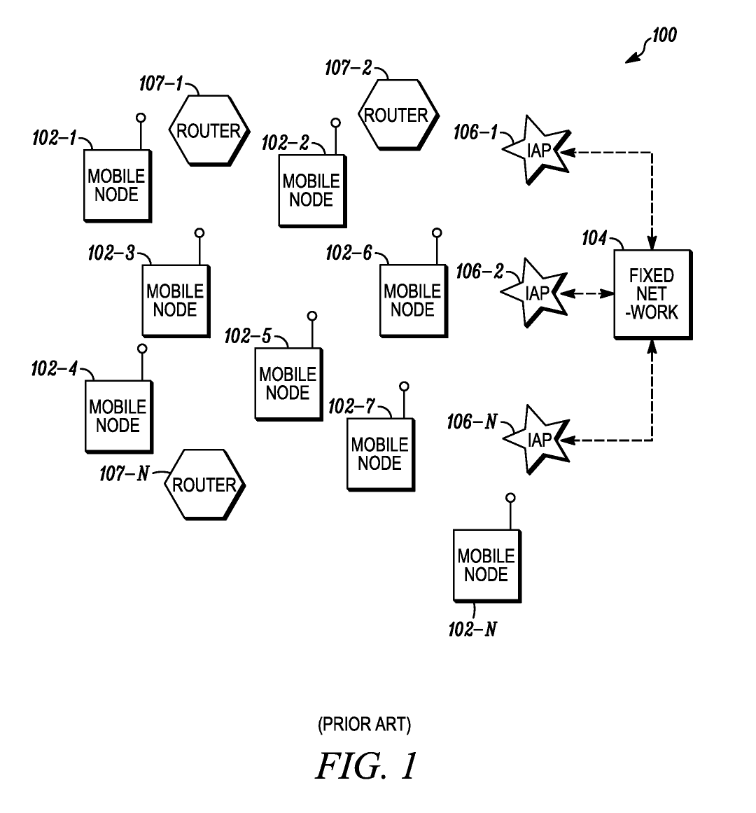

FIG. 1 is a block diagram illustrating an example of a communication network 100. The communication network 100 can be a mesh enabled architecture (MEA) network, an IEEE 802.11 network (i.e. 802.11a, 802.11b, 802.11g, 802.11e or 802.11s), or any other packetized mesh communication network.

As illustrated in FIG. 1, the communication network 100 includes a plurality of mobile nodes 102-1 through 102-n (referred to generally as nodes 102 or mobile nodes 102 or mobile communication devices 102), and can, but is not required to, include a fixed network 104 having a plurality of intelligent access points (IAP) 106-1, 106-2, . . . 106-n (referred to generally as nodes 106 or access points 106), for providing nodes 102 with access to the fixed network 104. The fixed network 104 can include, for example, a core local access network (LAN), and a plurality of servers and gateway routers to provide network nodes with access to other networks, such as other ad-hoc networks, a public switched telephone network (PSTN) and the Internet. The communication network 100 further can include a plurality of fixed or mobile routers 107-1 through 107-n (referred to generally as nodes 107 or communication devices 107) for routing data packets between other nodes 102, 106 or 107. It is noted that for purposes of this discussion, the nodes discussed above can be collectively referred to as “nodes 102, 106 and 107”, or simply “nodes” or alternatively as “communication devices.”

As can be appreciated by one skilled in the art, the nodes 102, 106 and 107 are capable of communicating with each other directly or indirectly. When communicating indirectly, one or more other nodes 102, 106 or 107, can operate as a router or routers for forwarding or relaying packets being sent between nodes.

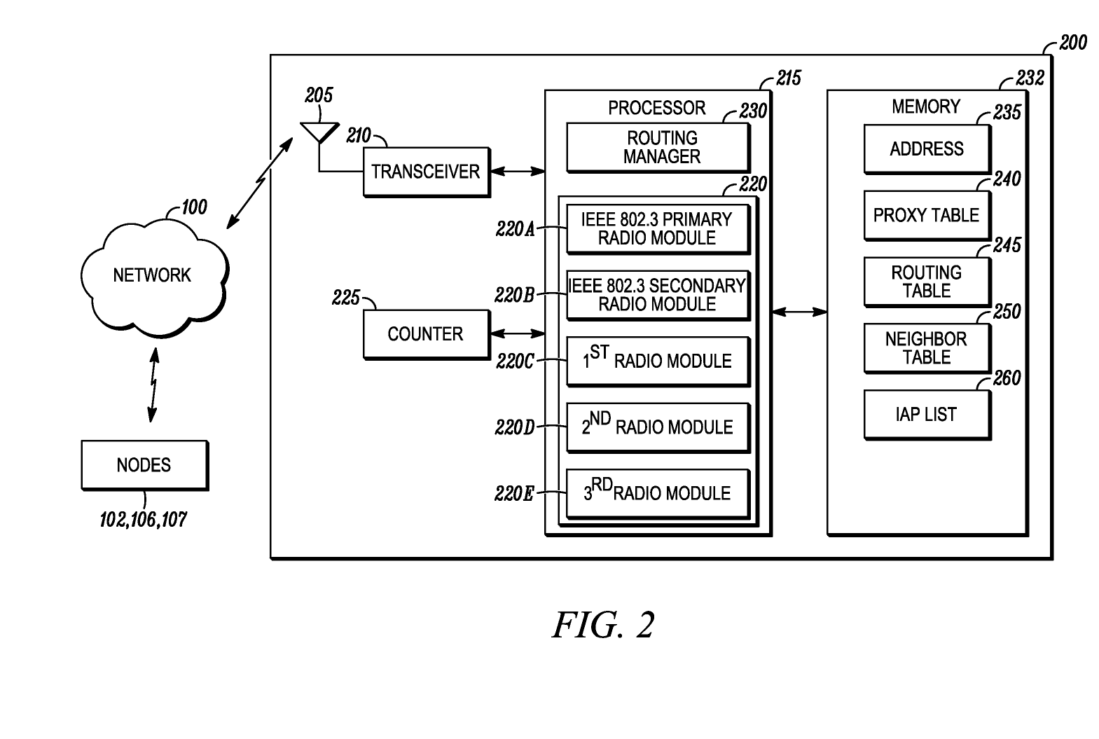

FIG. 2 is an electronic block diagram of one embodiment of a multi-radio meshed node or communication device 200. The communication device 200, for example, can exemplify one or more of the nodes 102, 106, and 107 of FIG. 1. In accordance with embodiments of the present invention, the communication device 200 can be referred to as “a mesh routable device.” As illustrated, the multi-radio meshed device 200 includes an antenna 205, a transceiver (or modem) 210, a processor 215, a counter 225 and a memory 232.

The antenna 205 intercepts transmitted signals from one or more nodes 102, 106, 107 within the communication network 100 and transmits signals to the one or more nodes 102, 106, 107 within the communication network 100. The antenna 205 is coupled to the transceiver 210, which employs conventional demodulation techniques for receiving and which employs conventional modulation techniques for transmitting communication signals, such as packetized signals, to and from the multi-radio meshed device 200 under the control of the processor 215. The packetized data signals can include, for example, voice, data or multimedia information, and packetized control signals, including node update information. When the transceiver 210 receives a command from the processor 215, the transceiver 210 sends a signal via the antenna 205 to one or more devices within the communication network 100. In an alternative embodiment (not shown), the multi-radio meshed device 200 includes a receive antenna and a receiver for receiving signals from the communication network 100 and a transmit antenna and a transmitter for transmitting signals to the communication network 100. It will be appreciated by one of ordinary skill in the art that other similar electronic block diagrams of the same or alternate type can be utilized for the multi-radio meshed device 200.

The processor 215 may include a routing manager 230 for managing packet forwarding within the communication network 100 and a plurality of radio modules 220A-220E each of which operate under the control of routing manager 230 to support multi-radio routing. Although the routing manager 230 can be contained within the processor 215 as illustrated, in alternative implementations, the routing manager 230 can be an individual unit operatively coupled to the processor 215 (not shown). It will be appreciated by those of ordinary skill in the art that the routing manager 230 can be hard coded or programmed into the node 200 during manufacturing, can be programmed over-the-air upon customer subscription, or can be a downloadable application. It will be appreciated that other programming methods can be utilized for programming the routing manager 230 into the multi-radio meshed device 200. It will be further appreciated by one of ordinary skill in the art that routing manager 230 can be hardware circuitry within the multi-radio meshed device 200.

In accordance with embodiments of the present invention which will be described in detail below, the processor 215 of the multi-radio meshed device 200 may include a plurality of radio modules 220A-220E each of which operate under the control of routing manager 230 to support multi-radio routing. Each of the radio modules 220A-220E can operate over at least one frequency different from that of the other radio modules, and has a particular radio configuration which supports certain data rates or sets of data rates, and may use a particular medium access control (MAC) protocol different from that of the other radio modules such as Carrier Sense Multiple Access With Collision Avoidance (CSMA/CA), Multiple Access with Collision Avoidance (MACA), Time Division Multiple Access (TDMA), Code Division Multiple Access (CDMA), Orthogonal Frequency Division Multiple Access (OFDMA) etc. Each of the radio modules 220A-220E includes its own physical (PHY) layer (not shown) and medium access control (MAC) layer (not shown) which comply with at least one radio network or radio network standard. Each PHY layer operates according to its own set of physical layer parameters (e.g., supported data rates, radio frequency (RF) channels, carrier spacing; modulation technique, coding techniques, etc.).

Radio modules 220A, 220B are illustrated as being compliant with the IEEE 802.3 standard in which radio module 220A is specifically for an IAP node. Examples of standards which the radio modules 220C-220E may comply with can include, but are not limited to, IEEE 802.11 network standards including 802.11a, 802.11b, 802.11g, 802.11n, 802.11e or 802.11s, and IEEE 802.16 network standards including 802.16j, and IEEE 802.15 network standards including 802.15.3, 802.15.4, etc. Radio modules 2202C-220E may also comply with a proprietary radio network such as a mesh enabled architecture (MEA) network, or any other packetized mesh communication network.

To perform the necessary functions of the multi-radio meshed device 200, the processor 215 and/or the routing manager 230 are each coupled to the memory 232, which preferably includes a random access memory (RAM), a read-only memory (ROM), an electrically erasable programmable read-only memory (EEPROM), and flash memory. It will be appreciated by those of ordinary skill in the art that the memory 232 can be integrated within the multi-radio meshed device 200, or alternatively, can be at least partially contained within an external memory such as a memory storage device. The memory 232 comprises an address table 235, proxy table 240, routing table 245, and a neighbor table 250.

### Address Table

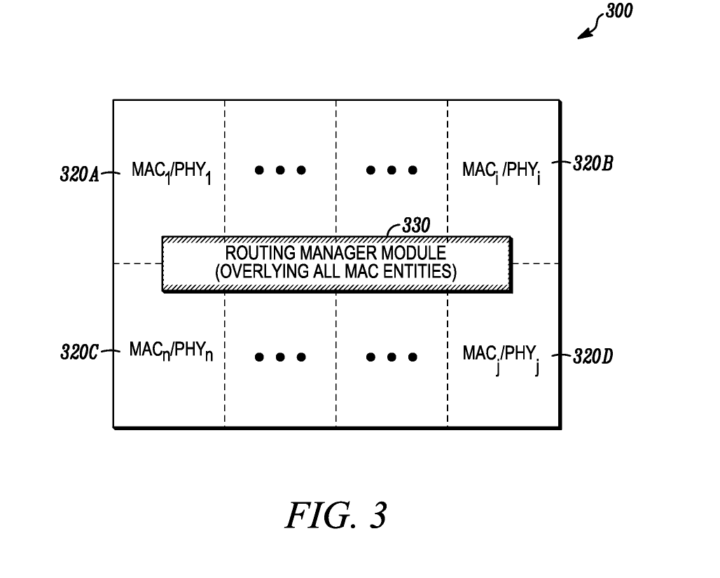

The address table 235 includes storage locations for the storage of one or more identifying addresses such as the MAC address of the multi-radio meshed device 200 and MAC addresses of the particular MAC modules in each radio module 220A-220E of the multi-radio meshed device 200. In accordance with embodiments of the present invention, the multi-radio meshed device 200 needs a unique MAC address to identify the multi-radio system as a single node even though, as illustrated for example with reference to FIG. 3, there is more than one MAC module controlled by the routing manager module 230 (also referred to above as a mesh routing core (MRC)), and each MAC module has its own unique MAC address (e.g., different MAC addresses for each MAC module). As used herein, the term “node MAC address,” refers to the unique MAC address identifying the multi-radio meshed device 200. As used herein, the term “interface MAC address,” refers to a MAC address of a particular radio module 220A-220E within the multi-radio meshed device 200. Each radio module 220A-220E in the multi-radio meshed device 200 and its corresponding MAC module has its own interface MAC address. In one embodiment, the “interface MAC address,” of the MAC module which powers up first is also used as the “node MAC address,” which identifies the multi-radio meshed device 200. In order to avoid node identifier module confusion due to failure of the first MAC, the “node MAC address” which identifies the multi-radio meshed device 200 will not be changed as long as the multi-radio meshed device 200 is alive. Thus, once the device 200 is powered up, it keeps the same node MAC address and will not change it due to the failure of any MAC module in this device. Each multi-radio meshed device 200 will maintain single destination sequence number for itself. In one embodiment, the destination sequence number maintenance rules can follow those specified in the AODV protocol defined in RFC 3561.

Because the multi-radio meshed device 200 is a routable or “meshed” device/node, the memory 232 further includes storage locations for maintaining or storing a proxy table 240 and a routing table 245. The routing table 245 and the proxy table 240 are maintained to identify a non-routable or non-meshed device 200 and its corresponding AP (routable device) 205; non-meshed devices are proxied by meshed devices. These tables can also be combined to create a single forwarding table.

### Proxy Table

To do the proxy routing for the non-routing devices, the routing manager module 230 of multi-radio meshed device 200 also maintains a proxy table to store all the information regarding the proxy nodes associated with this multi-radio meshed device 200 through different interfaces. The proxy table 240 typically contains an entry for each device that is associated with the multi-radio meshed device 200 (e.g., each device that is being proxied by the multi-radio meshed device 200). A multi-radio meshed device 200 can also have nodes or devices associated with it through a wired Ethernet port or through some other wired/wireless protocol like IEEE 802.15, Token Ring, or the like as can be appreciated by one skilled in the art. A proxy table 240 of a multi-radio meshed device 200 may also contain entries for non-meshed devices that are associated with other nodes but use that node as an intermediate node to communicate with other devices in the network.

In some embodiments, the routing manager module 230 of multi-radio meshed device 200 can perform the same proxy routing as defined in United States published patent application 20060098612, filed Sep. 7, 2005, entitled “System and method for associating different types of nodes with access point nodes in a wireless network to route data in the wireless network”, and United States published patent application 20060098611, filed Sep. 7, 2005, entitled “System and method for routing data between different types of nodes in a wireless network.”

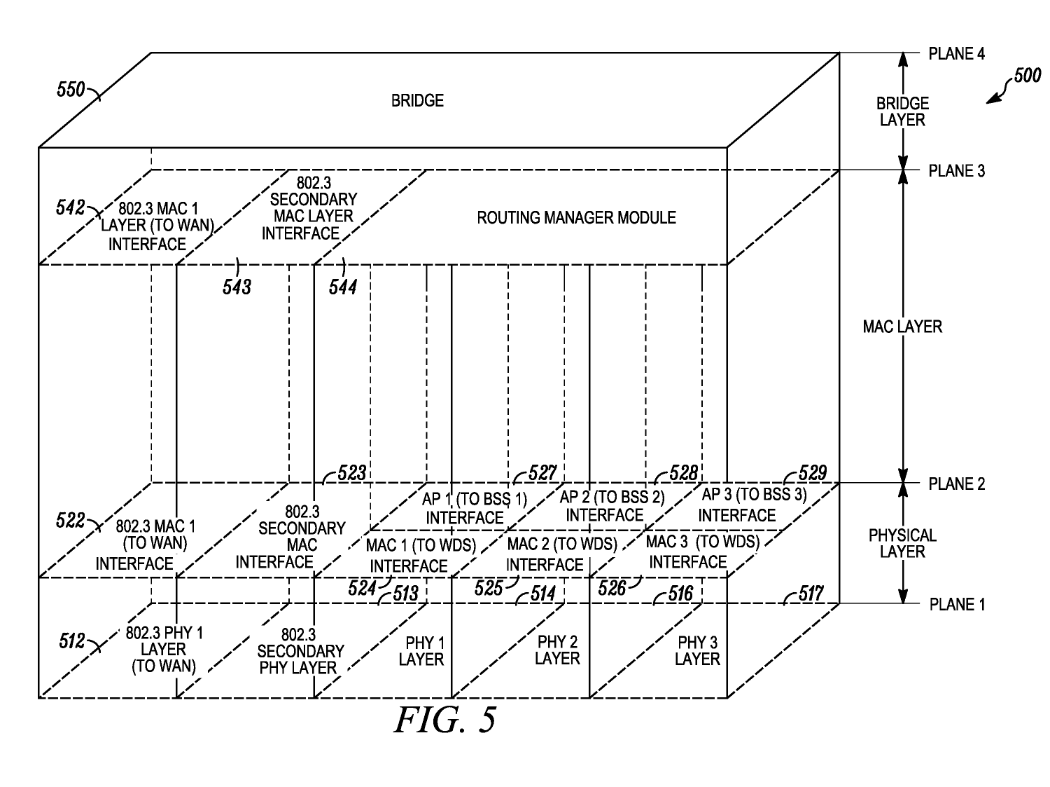

Each entry in the proxy table 240 comprises at least some of the following fields: a device MAC address field (also called as terminating address), an Interface MAC address from which the device is associated (discussed below in FIG. 5), a last time heard field, and an expiration time of the entry. Table 1 below illustrates the fields which can be included in an entry in the proxy table.

TABLE 1
Entry in the proxy table for Proxied Device 1

Device MAC address field
Interface MAC address from which the device is associated
Last Time Heard field
Expiration time of the entry

### Routing Table

The routing manager module 230 maintains a routing table 245 to store the route information concerning routes to other meshed devices. The node 200 constantly updates its routing table 245 so as to maintain a consistent and up-to-date view of the network. When the network topology changes the nodes propagate update messages throughout the network in order to maintain consistent and up-to-date routing information about the whole network. These routing protocols vary in the method by which the topology change information is distributed across the network and the number of necessary routing-related tables.

In accordance with some embodiments of the present invention, each individual entry in routing table 245 may comprise at some of the following fields: a Destination Node MAC Address field, a Destination Sequence Number field, a Valid Destination Sequence Number field, a Hop Count field (e.g., number of hops needed to reach destination), a Routing Metrics field, a Next Hop Node MAC Address field (e.g., the node MAC address of the next hop), an Interface Information field, a Lifetime field (expiration or deletion time of the route), an Routing Flags field, a Routing State field, a Precursor List field, and a Proxy Node List field (including nodes that are proxied by the destination node). Each entry in the Interface Information field comprises sub-fields for (a) a Local Transmitting Interface MAC Address (the local interface/radio to reach the next hop), and (b) a Next Hop Receiving Interface MAC Address. Each entry in the Precursor List comprises sub-fields for (a) MAC Address of the node, and (b) a Local Interface MAC Address (the local interface/radio to reach the precursor node). Table 2 below illustrates the fields which can be included in an entry in the routing table.

TABLE 2
Entry for Route 1 to Meshed Device 1

| | |
|---|---|
| Destination Node MAC Address field | |
| Destination Sequence Number field | |
| Valid Destination Sequence Number field | |
| Hop Count field | |
| Routing Metrics field | |
| Next Hop Node MAC Address field | |
| Interface Information field | Local Transmitting |
| | Interface MAC Address |
| | Next Hop Receiving |
| | Interface MAC Address |
| Lifetime field | |
| Routing Flags field | |
| Routing State field | |
| Precursor List field | MAC Address of the node |
| | Local Interface MAC |
| | Address |
| Proxy Node List field | |

Thus, in contrast to single-radio routing architectures, the data structures used in this multi-radio routing architecture also maintain related interface MAC addresses in addition to the node MAC addresses. For example, the Interface Information field records the local interface MAC address and the next hop interface MAC address to reach the next hop, and the Precursor List field maintains a list of nodes which are using this node through the interface recorded in the local interface MAC address field to reach the destination associated with this route entry.

The routing manager 230 of the multi-radio meshed device 200 consults both the proxy table 240 and the routing table 245 to determine how to forward a data packet it has either generated or has received.

### Neighbor Table

The routing manager module 230 also maintains a neighbor table 250 in memory 232 that contains the most current information about the neighbor nodes of the multi-radio meshed device 200. The multi-radio meshed device 200 maintains a list of neighbor nodes in the neighbor table 250. Neighbor nodes are added to the neighbor table 250 when the multi-radio meshed device 200 receives a communication from a neighbor node which indicates that the particular neighbor node is in communication range of the multi-radio meshed device 200. For example, in one implementation, a neighbor node will be added to the neighbor table 250 if the multi-radio meshed device 200 receives a HELLO message from that neighbor node. The routing manager module 230 maintains separate expiry timers for each neighbor on each interface. These expiry timers are updated every time a HELLO message is heard (or another directed message is received) from the neighbor node on that interface. For each neighbor node, the neighbor table 250 maintains information which comprises: a MAC address of neighbor, a device type of the neighbor node (which can be subscriber device (SD), wireless router (WR) or IAP), a MAC address of the IAP to which the neighbor node is currently bound (only in infrastructure state), the number of hops the neighbor node is from the IAP it is currently bound to (only in infrastructure state), Routing Metrics from the neighbor node to the IAP it is currently bound to (only in infrastructure state), and an Interface List which maintains interface information for each neighbor node which includes a list of all interfaces from which the neighbor node is heard.

In one embodiment, each entry of the Interface List comprises: a Local Interface MAC Address field (e.g., the interface from which the neighbor node is heard), a Neighbor Interface MAC Address field (e.g., the interface from which the neighbor node is advertised in the neighboring node), Routing Metrics to the neighbor node on this link, a Link Quality field which describes the link quality between the current node and the neighbor node on this link, and a lifetime field which specifies the expiration or deletion time of the neighbor node on this interface.

Table 3 below illustrates the fields which can be included in an entry in the neighbor table.

TABLE 3
Entry For Neighbor Node 1

| | |
|---|---|
| MAC address of neighbor node | |
| device type of the neighbor node | |
| MAC address of the currently bound IAP | |
| number of hops from the currently bound | |
| IAP | |
| Routing Metrics from the neighbor node | |
| to the currently bound IAP | |
| Interface List of all interfaces from which | Local Interface MAC Address |
| this neighbor node is heard. | field |
| | Neighbor Interface MAC |
| | Address field |
| | Routing Metrics field to the |
| | neighbor node on this link |
| | Link Quality field |
| | Lifetime field |

The entry in Table 3 is for example purposes only and other related information (not shown) may be included in other embodiments. This information can include capabilities of the neighbor node, capacity/congestion information, etc. Thus, in contrast to single-radio routing architectures, the data structures used in this multi-radio routing architecture also maintains interface information for each neighbor node.

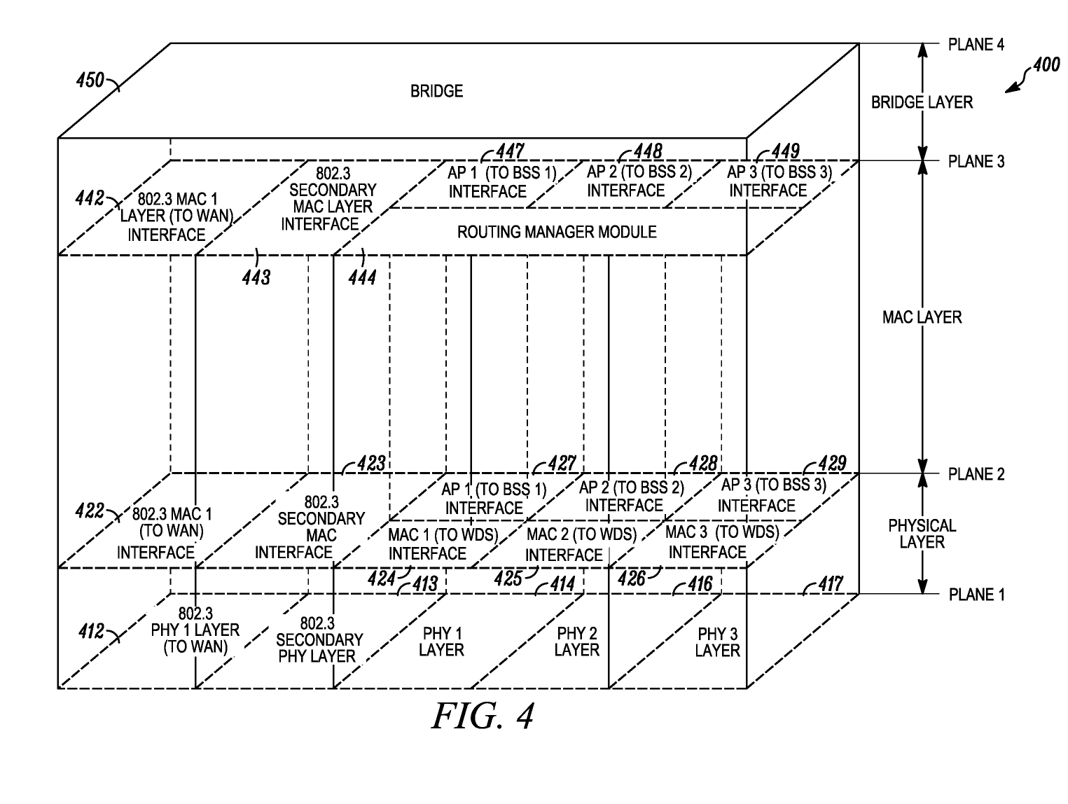

FIG. 3 is a conceptual diagram which illustrates a multi-radio meshed node which implements a multi-radio architecture 300 for routing over multi-radio platforms in accordance with some embodiments of the present invention. The multi-radio architecture 300 may comprise a chipset which comprises a routing manager 330 module and a plurality of radio modules 320A-320D. Each of the radio modules 320A-320D comprise a particular medium access control (MAC) layer module (MAC_{1, i, j, n}), and a particular physical (PHY) layer module (PHY_{1, i, j, n}). The routing manager 330 module is a routing module which, in some embodiments, can be implemented within the routing manager module 230 of FIG. 2. The routing manager 330 module overlies and is shared by the particular medium access control (MAC) layers (MAC_{1, i, j, n}) of each of the plurality of radios 320A-320D. The routing manager 330 module maintains the routing process for all the medium access control (MAC) layer modules (MAC_{1, i, j, n}) over the plurality of radios 320A-320D. Each of the particular medium access control (MAC) layer modules (MAC_{1, i, j, n}) maintains its own queue for the channel access and provides other link layer functionalities, and provides link layer and PHY layer feedback to the shared routing manager 330 module. Particular implementations of multi-radio architectures 400, 500 and 600 will be described below with reference to FIGS. 4, 5, 6.

### Multi-Radio Routing Architectures

FIGS. 4-6 are three-dimensional diagrams which illustrate multi-radio meshed nodes (e.g., meshed points (MPs), MAPs or IAPs) which implement multi-radio architectures 400, 500, 600 for routing over multi-radio platforms in accordance with some embodiments of the present invention.

As illustrated in FIGS. 4-6, each of the multi-radio meshed nodes has a multi-radio architecture 400, 500, 600 comprising a plurality of planes 1-4. Each of the multi-radio architectures 400, 500, 600 comprise a physical (PHY) layer (plane 1), a medium access control (MAC) lower interface layer (plane 2) and upper interface layer (plane 3), and a bridge layer (plane 4). The MAC lower interface layer (plane 2) includes a number of PHY/MAC interfaces. Each of the multi-radio architectures 400, 500, 600 includes a total of five radio modules, and a mesh routing core which controls routing with respect to three of those radio modules. The specific distinctions of each of the multi-radio architectures 400, 500, 600 will now be described.

Plane 1 of the multi-radio architecture 400 illustrated in FIG. 4 comprises five physical (PHY) layer modules 412-417. In this implementation, these are illustrated as a primary IEEE 802.3 physical layer module (PHY1) 412 (which applies only for IAP portal nodes), a secondary IEEE 802.3 physical layer module (PHY2) 413, a first IEEE 802.11(a) physical layer module (PHY1) 414, a second IEEE 802.11(g) physical layer module (PHY2) 416, and a third IEEE 802.11(b) physical layer module (PHY3) 417. It will be appreciated the present invention is not limited to these specific standards.

Plane 2 of the multi-radio architecture 400 illustrated in FIG. 4 comprises five PHY/MAC layer interfaces 422, 423, 424/427, 425/428, 426/429. PHY/MAC layer interface 424/427 includes a MAC1 interface 424 to WDS and an AP1 interface 427 to BSS 1. The 802.3 MAC 1 interface 422 applies only for IAP nodes. The MAC1 interface 424 is provided to connect to the MAC1 interface in the neighboring node through the WDS in the WDS packet format. The AP1 interface 427 is to serve the STAs associated with this MAP node through this particular interface. The coverage of the AP1 interface 427 is called as BSS1. Similarly, PHY/MAC layer interface 425/428 includes a MAC2 interface 425 to WDS and an AP2 interface 428 to BSS 2, while PHY/MAC layer interface 426/429 includes a MAC3 interface 426 to WDS and an AP3 interface 429 to BSS 3. Each pair of AP interface and MAC interface share the same physical (PHY) layer.

Plane 3 of the multi-radio architecture 400 illustrated in FIG. 4 comprises five MAC/Bridge layer interfaces 442, 443, 447-449, and a routing manager module 444. Specifically, the interface 442 is the upper reflection of interface 422, and a primary IEEE 802.3 medium access control module (MAC1) (which is specific for IAP) is embraced by these two interfaces, the interface 443 is the upper reflection of interface 423, and a secondary IEEE 802.3 medium access control module (MAC2) is embraced by these two interfaces, the interface 447 is the upper reflection of interface 427, and the AP1 medium access control module serving the STAs in the BSS1 is embraced by these two interfaces, and similarly 448, 449 are the upper reflections of interface 428, 429 respectively, and embraced the AP2 and AP3 medium access control modules serving BSS2 and BSS3 respectively. In this particular embodiment, there are three interfaces 424, 425, 426 exposed to the routing manager module 444, and three of the radio modules 414/424, 416/425, 417/426 are implemented under control of the routing manager module 444. Although the multi-radio architecture 400 of FIG. 4 shows three radio modules under control of the routing manager module 444, it will be appreciated that in other implementations less than or more than three radio modules could be controlled by the routing manager module 444.

Plane 4 of the multi-radio architecture 400 illustrated in FIG. 4 comprises the bridge layer module 450. The bridge layer module 450 connects different ports/interfaces and performs the data forwarding between the different ports/interfaces connected by the bridge layer module 450 according to IEEE 802.1 standards. The bridge layer module 450 does not have a “multi-hop” routing functionality that is provided by the routing manager module 444. In this particular embodiment, in addition to the routing manager module 444, there are five MAC layer modules 442, 443, 447-449 exposed to the bridge layer module 450.

Under the architecture illustrated in FIG. 4, the routing manager module 444 controls the traffic relaying in the WDS among different radios. The traffic destined to the BSS associated with the multi-radio system node or to the WAN through the MAC1 of this node or to the wired LAN through the MAC2 of this node is controlled by the bridge layer module 450.

In the particular embodiment illustrated in FIG. 5, plane 1, plane 2, and plane 4 are functionally similar to those described above with reference to FIG. 4, and therefore for sake of brevity will not be described here again. Plane 3 of the multi-radio architecture 500 illustrated in FIG. 5 comprises two MAC/bridge layer interfaces 542, 543 and a routing manager module 544. Specifically, the interfaces 542, 543 are upper interfaces of the primary IEEE 802.3 medium access control module (MAC1), and the secondary IEEE 802.3 medium access control module (MAC2) respectively. In this particular embodiment, there are six interfaces 524, 525, 526, 527, 528, 529 exposed to the routing manager module 544, and three of the radio modules 514, 516, 517 are implemented under control of the routing manager module 544. In this multi-radio architecture 500, the routing manager module 544 maintains the interface information for each proxy device so that the routing manager module 544 can deliver packet(s) to the correct interface. In this particular embodiment, in addition to the routing manager module 544, there are two MAC layer modules 542, 543 exposed to the bridge layer 550. As above, although the multi-radio architecture 500 of FIG. 5 shows three radio modules under control of the routing manager module 544, it will be appreciated that in other implementations less than or more than three radio modules could be controlled by the routing manager module 544. Under the architecture illustrated in FIG. 5, the routing manager module 544 controls the traffic relaying in the WDS among different radios as well as the traffic destined to the BSS associated with the multi-radio system node. The traffic destined to the WAN through the MAC1 of this node or to the wired LAN through the MAC2 of this node is controlled by the bridge module 550. Routing module 544 maintains the routing information in the WDS as well as the proxy information in all BSSs served by this multi-radio meshed node.

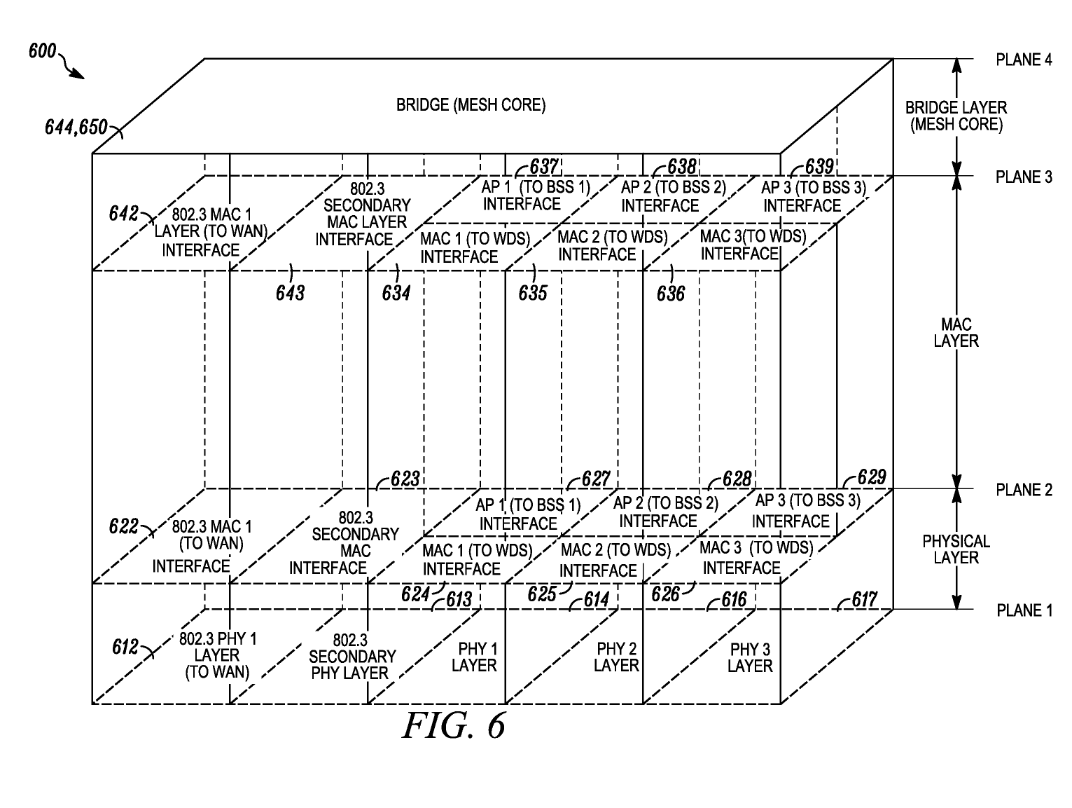

In the particular embodiment illustrated in FIG. 6, plane 1 and plane 2 are functionally similar to those described above with reference to FIG. 4, and for sake of brevity therefore will not be described here again. In FIG. 6, plane 3 of the multi-radio architecture 600 illustrated in FIG. 6 comprises five MAC layer modules 642, 643, 634/637, 635/638 and 636/639 all of which are exposed to the bridge layer 650/routing manager module 644. Specifically, the MAC layer modules 642, 643, 634/637, 635/638 and 636/639 include a primary IEEE 802.3 medium access control layer (MAC1) 642, a secondary IEEE 802.3 medium access control layer (MAC2) 643, a medium access control (MAC1) layer 634 (to WDS) and an AP1 medium access control layer 647 (to BSS 1), a medium access control (MAC2) layer 635 (to WDS) and an AP2 medium access control layer 648 (to BSS 2), and a medium access control (MAC3) layer 636 (to WDS) and an AP3 medium access control layer 649 (to BSS 3). Planes 3 and 4 have been modified by bringing the routing manager module 644 into the bridge layer 650. As such, in this multi-radio architecture 600, the routing manager module 644 is further pushed up to the bridge 650, and the bridge 650 behaves as a bridge router (brouter). In this case, the bridge 650 will execute both bridge and mesh routing functionality to deliver packet(s) to the correct interface. All three of the radio modules 614/624, 616/625, 617/626 are implemented under control of the routing manager module 644. As above, although the multi-radio architecture 600 of FIG. 6 shows three radio modules under control of the routing manager module 644, it will be appreciated that in other implementations less than or more than three radio modules could be controlled by the routing manager module 644.

### IAP Priority List

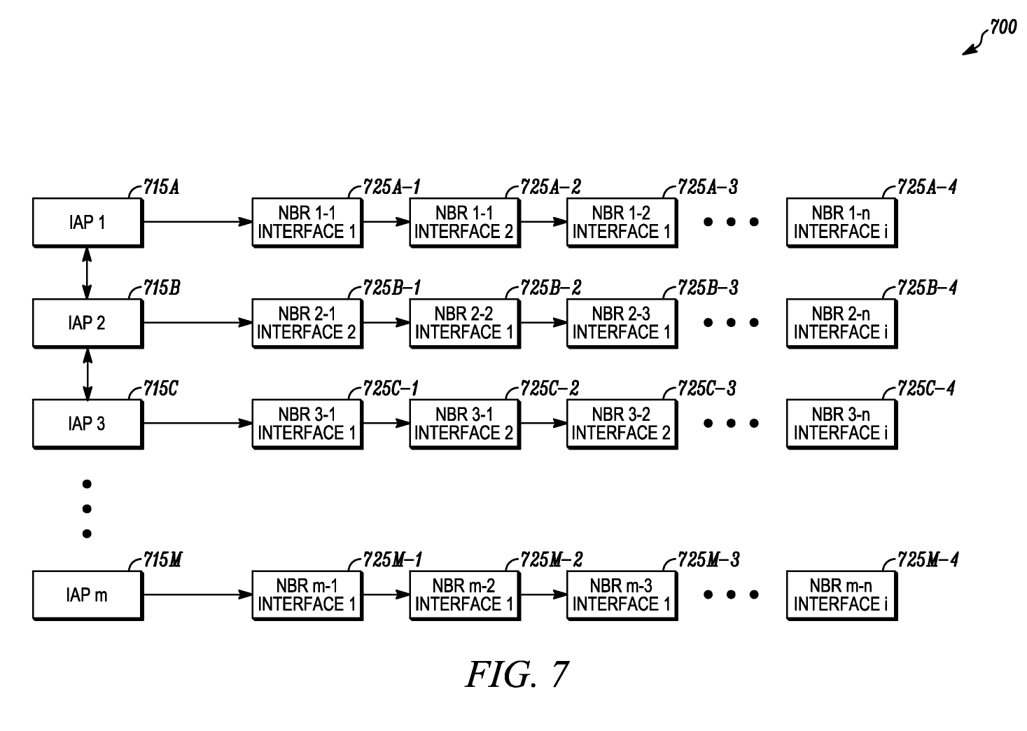

FIG. 7 is a block diagram which illustrates the structure of an IAP priority list 700 maintained by a routing manager module 230 in accordance with some embodiments of the present invention.

The IAP priority list 700 is used in the “infrastructure state” when an IAP (or IAPs) is present in the network. In the IAP priority list 700, the routing manager module 230 maintains a list of IAPs 715A-715m being advertised by its neighbor nodes. As shown in columns 2-5 of FIG. 7, for each of the IAPs 715A-715m, the routing manager module 230 sorts and maintains a sorted list of neighbor node/interface pairs 725. For each of the IAPs 715A-715m, the routing manager module 230 sorts neighbor nodes/interface pairs 725 based on their routing metrics to their bound IAP so that, for each IAP 715A-715m, the routing manager module 230 has a sorted IAP priority list of neighbor nodes and their corresponding interfaces which can be used to reach a particular IAP. The routing manager module 230 also records the IAPs currently bound to this multi-radio meshed node, current next hop node and interface to its currently bound IAP, and the current routing metrics to its currently bound IAP. It compares the IAP candidate route metrics maintained in the IAP priority list against the current routing metrics to its current bound IAP, and makes proactive routing decision before the current route to its bound IAP deteriorates significantly.

In the embodiment illustrated in FIG. 7, the routing manager module 230 maintains a list of IAPs 1 . . . m, as well as the corresponding neighbor nodes 1 . . . m which advertise those IAPs 1 . . . m, and the interfaces 1 . . . i that those neighbor nodes 1 . . . m use to advertise those IAPs 1 . . . m.

For example, with respect to IAP1 715A, ranked from best routing metrics to worst routing metrics, neighbor node 1-1 is currently advertising IAP1 715A on Interface 1 725A-1 and on Interface 2 725A-2, neighbor node 1-2 is currently advertising IAP1 715A on Interface 1 725A-3, and neighbor node 1-n is currently advertising IAP1 715A on Interface i 725A-4.

With respect to IAP2 715B, ranked from best routing metrics to worst routing metrics, neighbor node 2-1 is currently advertising IAP2 715B on Interface 2 725B-1, neighbor node 2-2 is currently advertising IAP2 715B on Interface 1 725B-2, neighbor node 2-3 is currently advertising IAP2 715B on Interface 1 725B-3, and neighbor node 2-n is currently advertising IAP2 715B on Interface i 725B-4.

With respect to IAP3 715C, ranked from best routing metrics to worst routing metrics, neighbor node 3-1 is currently advertising IAP3 715C on Interface 1 725C-1 and Interface 2 725C-2, neighbor node 3-2 is currently advertising IAP3 715C on Interface 2 725C-3, and neighbor node 3-n is currently advertising IAP3 715C on Interface i 725C-4.

With respect to IAPm 715m, ranked from best routing metrics to worst routing metrics, neighbor node m-1 is currently advertising IAPm 715m on Interface 1 725m-1, neighbor node m-2 is currently advertising IAPm 715m on Interface 1 725m-2, neighbor node m-3 is currently advertising IAPm 715m on Interface 1 725m-3, and neighbor node m-n is currently advertising IAPm 715m on Interface i 725m-4.

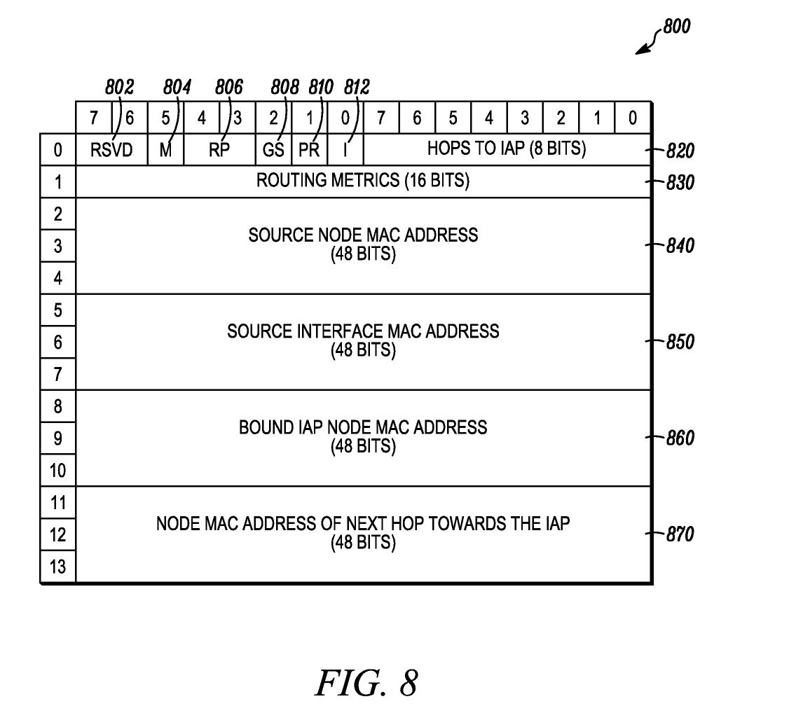

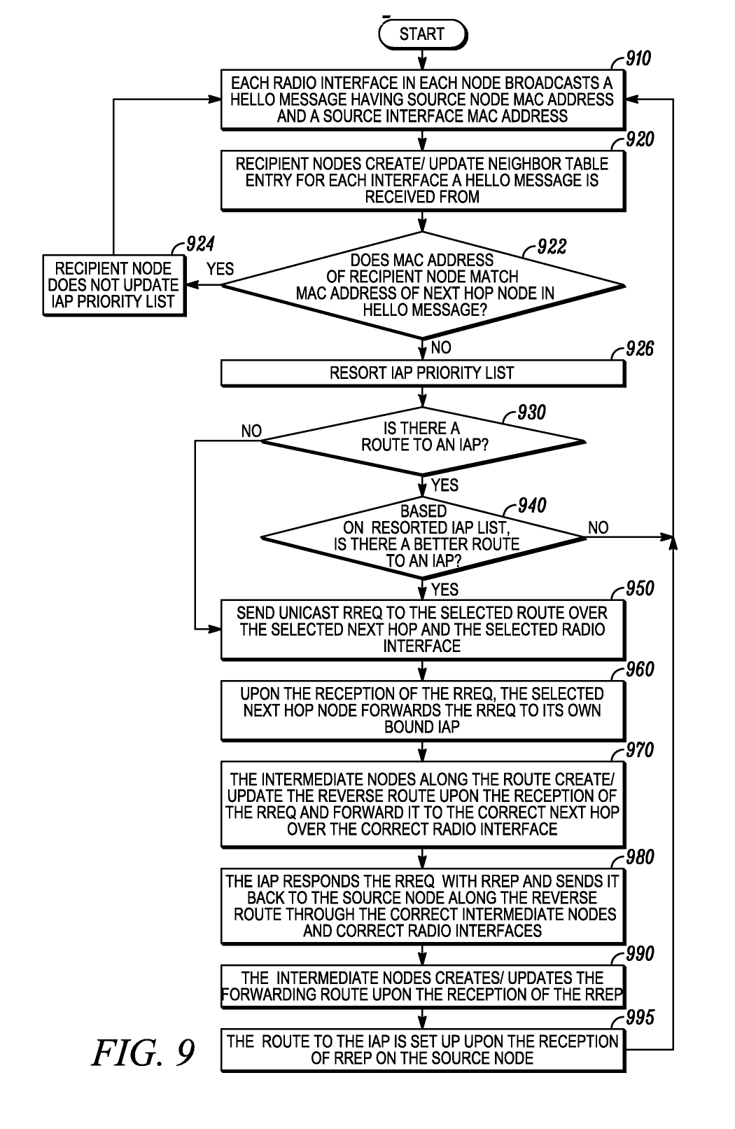

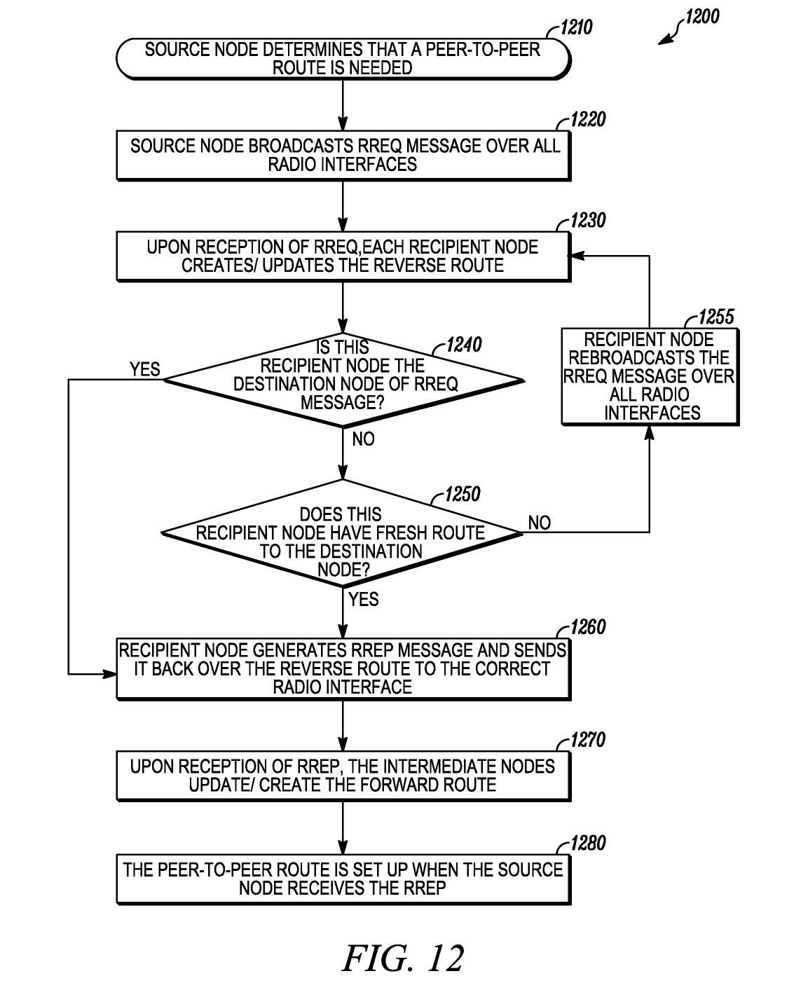

Prior to describing techniques for IAP route discovery (FIGS. 9-11) and for peer-to-peer route discovery (FIG. 12), a detailed description of a HELLO message format 800 (FIG. 8A) and techniques for processing a HELLO message (FIG. 8A) will be described in accordance with some embodiments of the present invention.

### HELLO Message

Referring again to FIG. 2, the routing manager module 230 uses HELLO messages to proactively discover the best route to the IAP. Each node periodically generates and broadcasts HELLO messages over-the-air (OTA) to announce a variety of information associated with the node, its bound IAP and the next hop node towards its bound IAP. Throughout the description the term “HELLO message” is used to describe a communication which includes addressing and routing information. It can be a beacon message, neighbor advertising message, routing advertising message, or link state advertising message. FIG. 8, described below, provides one example of a “HELLO message,” however, it should be appreciated that the term “HELLO message” is not to be interpreted in a restrictive sense. Rather the term “HELLO message” is used throughout the description as merely one example of a type of message which can be used to communicate addressing and routing information. A “HELLO message” can generally be regarded as an information element or field that can be included as part of another message such as a standard HELLO message, a beacon, an advertisement message such as a routing advertisement message, a link advertisement message, etc.

FIG. 8 is a data structure which illustrates a format of a HELLO message 800 in accordance with some embodiments of the present invention.

The HELLO message 800 includes reserved (Rsvd) bits 802 which are reserved for future use, a mobility flag (M) bit 804 which specifies whether the node is a mobile node, routing preference flag (RP) bits 806 which are used for indicating the level of preference of forwarding traffic for other nodes, and the higher values indicate a more desirable node for routing traffic, a geo server flag (GS) bit 808 which is used for indicating whether this node is a geo server, a proxy flag (Pr) bit 810 which is used for indicating whether the node support proxy functionality, an IAP flag (I) bit 812 which is used for indicating whether this is an IAP, a hops-to-IAP field 820 which specifies the number of hops from the sending node to the bound IAP, a routing metrics field 830 which specifies routing metrics associated with the route from the sending/source node to the IAP the sending/source node is bound to, a source node MAC address field 840 which specifies the MAC address of the sending/source node, an interface MAC address field 850 which specifies the MAC address of the interface of the sending/source radio module, a bound IAP node MAC address field 860 which specifies the MAC address of the IAP node that the sending/source node is bound to, and a next hop node MAC address field 870 which specifies the MAC address of the next hop node towards the IAP (i.e., this field carries the node MAC address of the next hop towards the IAP).

### IAP Route Discovery

FIG. 9 is a flowchart illustrating a method 900 for IAP route discovery by a multi-radio meshed node in accordance with some embodiments of the present invention. The method 900 for intelligent access point (IAP) route discovery can be used by a multi-radio meshed node to establish an optimal route to an intelligent access point (IAP) when the IAP presents itself in a network. In the following description, it is assumed that a wireless multi-hop network includes a plurality of multi-radio meshed nodes. Each multi-radio meshed node comprises a plurality of radio modules, and each radio module comprises an interface. Although FIG. 9 will be described with respect to an embodiment in which there are pluralities of multi-radio meshed nodes, it will be appreciated that the same method can be applied in the context of a single multi-radio meshed node.

Method 900 starts at step 910, where each multi-radio meshed node broadcasts HELLO messages 800 over all of its radio interfaces. That is, each multi-radio meshed node will transmit multiple HELLO messages since each of its radio modules transmits or broadcasts its own HELLO message over-the-air (OTA). Each HELLO message transmitted by each of the radio modules comprises: a source node MAC address field 840 which specifies a first MAC address of the particular multi-radio meshed node that is the source of the HELLO message 800, and a source interface MAC address field 850 associated with the particular radio module of the particular multi-radio meshed node and which specifies the interface MAC address of the particular radio module that is the source of the HELLO message 800. In other words, each of the radio interfaces in each multi-radio meshed device 200 broadcasts its own HELLO message 800. Each HELLO message transmitted from a particular multi-radio meshed device 200 includes the same source node MAC address field 840 (which specifies the MAC address of the source node), but its own interface MAC address in interface MAC address field 850 which indicates the MAC address of the interface of the source/sending radio module of that particular multi-radio meshed device 200. As illustrated in FIG. 8, each HELLO message may also further comprise: routing metrics to an IAP node the particular multi-radio meshed node is currently bound to; a bound IAP node MAC address field 860 which specifies a MAC address of the IAP node that the particular multi-radio meshed node is currently bound to; and a next hop node MAC address field 870 which specifies a MAC address of the next hop node towards the IAP that the particular multi-radio meshed node is currently bound to.

Each multi-radio meshed node (other than the IAP) maintains the sorted IAP priority list according to the route metrics to the IAP from each neighbor multi-radio meshed node over each of the interfaces of those neighbor multi-radio meshed nodes. At step 920, upon receiving a HELLO message, the routing manager module 230 in each multi-radio meshed node (referred to hereafter as recipient multi-radio meshed node(s)), records the source interface MAC address field from each HELLO message (i.e., HELLO message reception interfaces), and updates the neighbor table 250 entry stored at the recipient multi-radio meshed node with the source interface MAC address field from each HELLO message (or creates a new neighbor table 250 entry if this is the first time a HELLO message has been heard from this neighbor multi-radio meshed node on this particular radio interface). In both cases, the expiry timer of the associated interface list entry is extended. Also, if the same HELLO message is heard from different radio interfaces, each should create or update interface list entry in the neighbor table entry for the neighboring multi-radio meshed node sending the HELLO message, and be inserted into the IAP priority list as if they are from different neighbor multi-radio meshed nodes.

To confirm that the particular recipient multi-radio meshed node is the intended recipient of the HELLO message, each particular recipient multi-radio meshed node can run a check to determine if a MAC address field of the particular recipient multi-radio meshed node matches the next hop node MAC address field. In this embodiment, at step 922, the recipient multi-radio meshed node compares its own node MAC address with the one in the “Next Hop Address” field of the HELLO message to determine if these addresses match and thereby confirm whether the recipient multi-radio meshed node is the “intended” recipient.

If these two addresses match, then at step 924, the multi-radio meshed node receiving the HELLO message will not put the neighbor in the IAP priority list 700. This makes sure that there is no loop or delay in acquiring the routes to the IAP if the current route is lost.

If the next hop is different than the current multi-radio meshed node, this HELLO message is accepted for further processing. At step 926, the IAP priority list 700 is re-sorted. Based on the route metrics to the IAP(s) over different neighboring multi-radio meshed node(s) and their different radio interface(s), each recipient multi-radio meshed node creates or re-sorts its IAP priority list (e.g., FIG. 7) to generate a re-sorted IAP priority list.

At step 930, each recipient multi-radio meshed node determines whether or not there is a route to an IAP. If the recipient multi-radio meshed node determines there is not a route to an IAP, then the method 900 proceeds to step 950.

If the recipient multi-radio meshed node determines there is a route to an IAP, then the method 900 proceeds to step 940 where the recipient multi-radio meshed node determines, based on its re-sorted IAP priority list (FIG. 7), whether or not there is a better route to an IAP (which is presumed to be the best candidate in the IAP priority list).

If the recipient multi-radio meshed node determines that there is not a better route to an IAP, then the method 900 loops back to step 910. On the other hand, if the recipient multi-radio meshed node determines that there is a better route to an IAP, then the method 900 proceeds to step 950, where the routing module of the recipient multi-radio meshed node initiates a new route discovery process (steps 950-995) to set up the new better route to an IAP.

At step 950, the recipient multi-radio meshed node sends a unicast route request (RREQ) message 1000 (described below) to the next hop node along the better route to the IAP. In other words, the recipient multi-radio meshed node sends the RREQ message 1000 over the better route towards the IAP, by sending the RREQ message 1000 to the selected radio interface of the next hop node along the better route. The next hop node along the better route can be a new neighboring node, or the same neighboring node but from the different radio interface to reach the IAP.

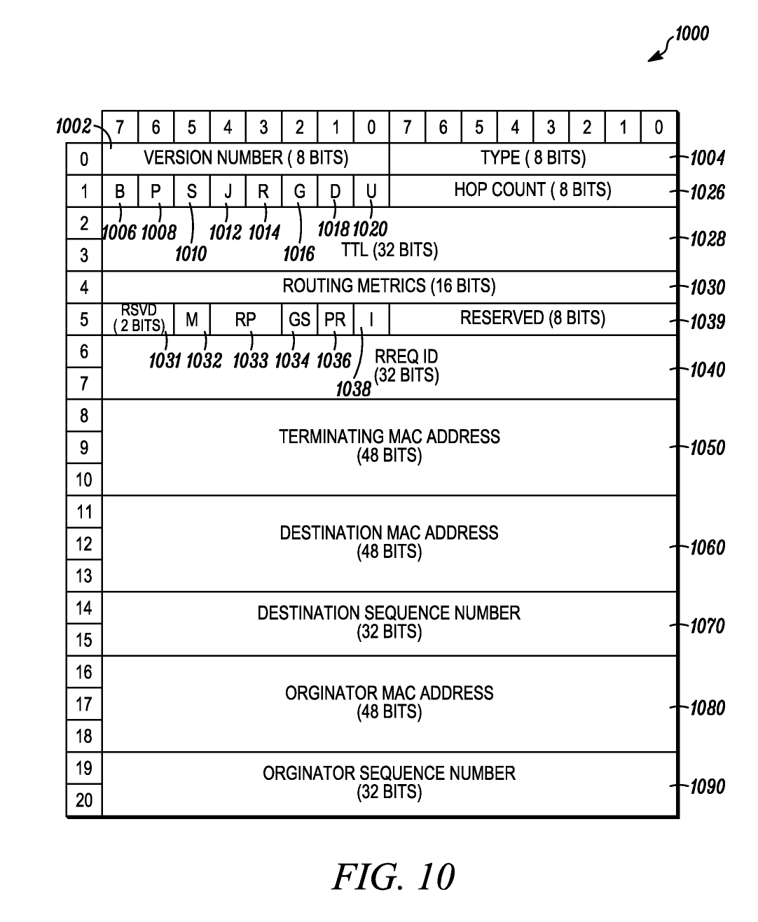

FIG. 10 is a data structure which illustrates a format of a route request (RREQ) message 1000 in accordance with some embodiments of the present invention. In this embodiment, all of the MAC addresses carried in the RREQ message 1000 are 48-bit node MAC addresses.

In this format, the RREQ message 1000 comprises a version number field 1002 which indicates a version number of the routing protocol, a type field 1004 which indicates a type of the message which is a RREQ message, a broadcast flag bit (B) 1006 which indicates that this is a broadcast RREQ or a unicast RREQ, a periodicity flag bit (P) 1008 which indicates that this is a periodic RREQ or non-periodic RREQ, a state flag bit (S) 1010 which indicates the source node is in the infrastructure state where the IAP is present in the network or in the ad hoc state where the IAP is absent in the network, a join flag bit (J) 1012 which indicates this is a multicast join RREQ or not, a repair flag bit (R) 1014 which indicates this is a repair RREQ or not, a gratuitous route reply (RREP)_flag bit (G) 1016 which indicates whether a gratuitous RREP should be unicast to the node specified in the Destination MAC Address field by the intermediate node which is responding to this RREQ with a RREP, a destination only flag bit (D) 1018 which indicates only the destination node may respond to this RREQ, and an unknown sequence number bit (U) 1020 which indicates the destination sequence number is unknown at the source/originator node, a hop count field 1026 which indicates the number of hops from the Originator node to the node handling the RREQ, a time-to-live (TTL) field 1028 which indicates the expected end-to-end route metric for the current round of expanding ring search, a routing metrics field 1030 which indicates accumulated routing metrics from the originator node to the node handling the RREQ, reserved (Rsvd) bits 1031 which are reserved for future use, a mobility flag (M) bit 1032 which specifies the initiating node is mobile node or static node, routing preference flag (RP) bits 1033 which are used for indicating the preference level of the originator node for forwarding traffic for other node, a geo server flag (GS) bit 1034 which is used for indicating whether the originator node is a geo server, a proxy flag (Pr) bit 1036 which is used for indicating whether the originator node supports proxy functionality for non-mesh/non-routable devices, an IAP flag (I) bit 1038 which is used for indicating whether the originator node is an IAP, reserved bits field 1039, a route request (RREQ) ID field 1040 which is a sequence number uniquely identifying the particular RREQ when taken in conjunction with the originating node's MAC address, a terminating MAC address field 1050 which specifies a MAC address of the terminating node to which data will be sent, and this can be equal to the destination MAC address if the terminating node is a meshed/routable device, a destination MAC address field 1060 which specifies a MAC address of the destination for which a route is desired, and this can be the node proxying for the terminating node if the terminating node is a non-meshed/non-routable device, a destination sequence number field 1070 which specifies a sequence number of route to the particular destination, an originator MAC address field 1080 which specifies a MAC address of the node which originated the RREQ, and an originator destination sequence number field 1090 which specifies a routing sequence number of the originator node.

Referring again to FIG. 9, at step 960, upon receiving the RREQ message 1000, the next hop node (along the better route towards the IAP) forwards the RREQ message 1000 towards the IAP following the routing rules defined, for example, in the AODV protocol (RFC 3561).

At step 970, upon reception of the RREQ message 1000, the intermediate nodes along the better route create or update a reverse route, and forward the RREQ message 1000 to the correct next hop node over the correct radio interface. When the reverse route entry is created or updated, besides creating/updating the reverse route entry following the AODV protocol (RFC 3561), the intermediate nodes also record the local interface MAC address from which the RREQ message 1000 is received and the sending node interface MAC address in the route table entry interface information field. The intermediate nodes also look up a neighbor table to get the sending node's MAC address and record it as the next hop address in the route table entry for the source node.

At step 980, the IAP, in response to the RREQ message 1000, sends a route reply (RREP) message 1100, to the source multi-radio meshed node along the reverse route through the correct intermediate nodes and their correct radio interfaces.

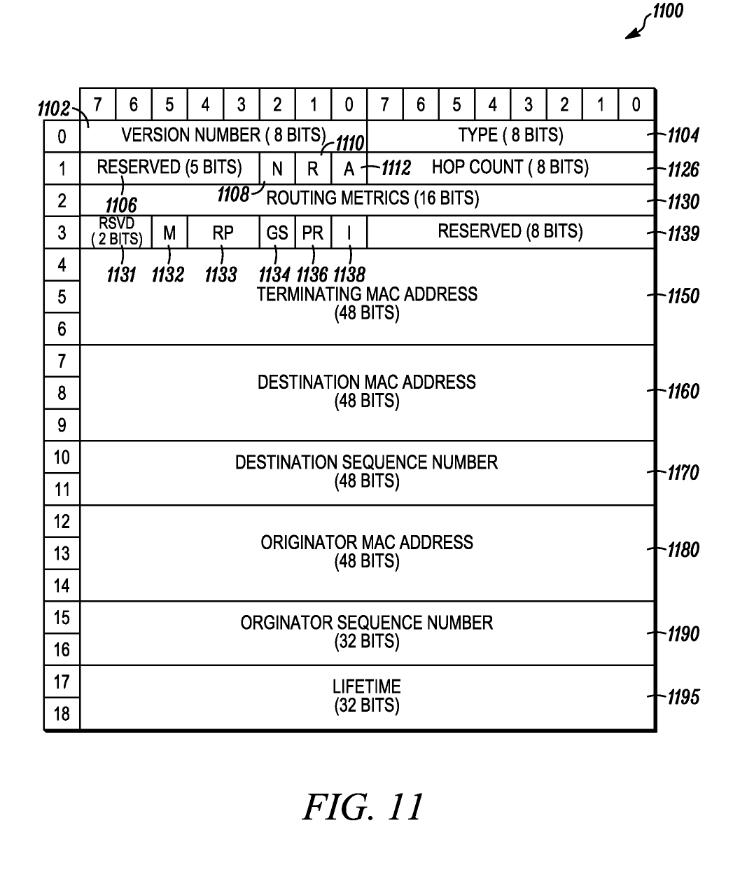

FIG. 11 is a data structure which illustrates a format of route reply (RREP) message 1100 in accordance with some embodiments of the present invention. In this embodiment, all of the MAC addresses carried in the RREP message 1100 are 48-bit node MAC addresses.

In this format, the RREP message 1100 comprises a version number field 1102 which indicates a version number of the routing protocol, a type field 1104 which indicates a type of the message which is RREP message, reserved bits 1106 which are reserved for future use, a new route flag bit (N) 1108 which indicates that this is a new route, a repair flag bit (R) 1110 which indicates whether it is for repair purpose or not, an acknowledge flag bit (A) 1112 which indicates whether the acknowledgement is required or not, a hop count field 1126 which indicates the number of hops to the from the destination node to the node handling the RREP, a routing metrics field 1130 which indicates the accumulated routing metrics from the destination node to the node handling the RREP, reserved (Rsvd) bits 1131 which are reserved for future use, a mobility flag (M) bit 1132 which specifies the initiating node is a mobile node or static node, routing preference flag (RP) bits 1133 which are used for indicating the preference level of the destination node to forward traffic for other nodes, a geo server flag (GS) bit 1134 which is used for indicating whether the destination node is a geo server, a proxy flag (Pr) bit 1136 which is used for indicating whether the destination node supports proxy functionality, an IAP flag (I) bit 1138 which is to indicate whether the destination node is an IAP, reserved bits field 1139, a terminating MAC address field 1150 which specifies a MAC address of the final terminal, a destination MAC address field 1160 which specifies a MAC address of the destination for which a route is supplied, a destination sequence number field 1170 which specifies a sequence number of the route to the destination node, an originator MAC address field 1180 which specifies a MAC address of the node which originated the RREQ for which the route is supplied, an originator destination sequence number field 1190 which specifies a sequence number of the originator node, and a lifetime field 1195 specifying the lifetime for the supplied route.

Referring again to FIG. 9, at step 980, when the IAP responds to the RREQ message 1000 with the RREP message 1100, the RREP message 1100 will be forwarded back along the reverse route towards the source multi-radio meshed node.

At step 990, upon reception of the RREP message 1100 by each intermediate node on the reverse route, the intermediate node(s) process the RREP message 1100 to create or update the forward route entry for the destination node. When the forward route entry is created or updated, besides creating/updating the reverse route entry, the intermediate nodes also records the local interface MAC address (from which the RREP message 1100 is received) and the sending node's interface MAC address in the route table entry interface information field. The receiving node can then look up the neighbor table to obtain the sending node MAC address and record it as the next hop address in the route table entry for the destination node. After updating the route table, each intermediate node will check the route table to get the next hop interface MAC address and the local radio interface MAC address leading to the source node, and forward the RREP message 1100 towards the source node.

At step 995, upon the reception of the RREP message 1100 at the source multi-radio meshed node, the better route to the IAP is set.

### Peer-to-Peer Route Discovery

When a source multi-radio meshed node needs to communicate with a destination node but there is no peer-to-peer route between these two nodes, the source needs to set up a peer-to-peer route.

FIG. 12 is a flowchart illustrating a method 1200 for peer-to-peer route discovery in accordance with some embodiments of the present invention.

Method 1200 starts at step 1210 when a source multi-radio meshed node determines that a peer-to-peer route needs to be set up. At step 1220, the source multi-radio meshed node broadcasts a RREQ message 1000 Over-the-Air (OTA) on all of its available radio interfaces.

At step 1230, each particular recipient multi-radio meshed node that receives the RREQ message (referred to hereafter as recipient multi-radio meshed node(s)), creates or updates the reverse route to the source node. For example, in one embodiment, when a recipient multi-radio meshed node receives the RREQ message 1000, it will process the packet, for example, following the rules specified in the RFC 3561 AODV. The RREQ message 1000 from the different radio interfaces of the same neighboring nodes are treated as if they are from different neighboring nodes. The recipient multi-radio meshed node compares the route information carried in the RREQ message 1000 against the one in the existing route entry for the reverse route if there is one. If the RREQ message 1000 is accepted following the routing rules, the reverse route entry is created or updated. When the reverse route entry is created or updated, besides creating/updating the reverse route entry, the particular recipient multi-radio meshed node also records the local interface MAC address from which the RREQ message 1000 is received and the sending node interface MAC address in the route table entry interface information field, and looks up the neighbor table to get the sending node MAC address and records it as the next hop address in the route table entry for the source node.

At step 1240, each recipient multi-radio meshed node determines whether or not it is the destination node of the RREQ message. If the particular recipient multi-radio meshed node is the destination node, then at step 1260, the particular recipient multi-radio meshed node generates a RREP message and sends it back over the reverse route to the correct radio interface.

If the recipient multi-radio meshed node is not the destination node, then the method 1200 proceeds to step 1250, where the particular recipient multi-radio meshed node determines if it has another “fresh” route to the destination node.

If the particular recipient multi-radio meshed node determines that it does not have another route to the destination node, then at step 1255, the particular recipient multi-radio meshed node re-broadcasts the RREQ message over all of its radio interfaces, and the method 1200 loops back to step 1230. Thus, in one embodiment, after processing the RREQ message 1000, if the recipient multi-radio meshed node is not the destination node and does not have a fresh route to the destination node, the recipient multi-radio meshed node updates the RREQ message 1000, for example, as defined in the AODV protocol (RFC3561) and re-broadcasts the packet over all of its available radio interfaces.

If the particular recipient multi-radio meshed node determines that it has a fresh route to the destination node, then at step 1260, the particular recipient multi-radio meshed node generates a RREP message and sends it back along the reverse route to the correct radio interface. For example, in one embodiment, when the destination node (or an intermediate node having a fresh route to the destination node) receives the RREQ message 1000, it will create or update the reverse route entry for the source node and generate the route reply (RREP) message 1100 and send the RREP message 1100 back to the source node. The RREP message 1100 will be forwarded back along the reverse route to the correct radio interface.

From step 1260, the method proceeds to step 1270 where each intermediate multi-radio meshed node that receives the RREP message (hereinafter referred to as intermediate multi-radio meshed node(s)), creates or updates the forward route to the destination node. For example, on the reverse route, each intermediate multi-radio meshed node on the route will process the RREP message 1100 to create or update the forwarding route entry for the destination node. When the forwarding route entry is created or updated, besides creating/updating the reverse route entry, the intermediate multi-radio meshed node also records the local interface MAC address from which the RREP message 1100 is received and the sending node interface MAC address in the route table entry interface information field, and looks up the neighbor table to obtain the sending node MAC address and records it as the next hop address in the route table entry for the destination node. After updating the route table, each intermediate multi-radio meshed node checks the route table to obtain the next hop interface MAC address and the local radio interface MAC address leading to the source multi-radio meshed node, and forwards the RREP message 1100 towards the source multi-radio meshed node.

At step 1280, the peer-to-peer route is established or “set up” when the source multi-radio meshed node receives the RREP message. As such, when the source multi-radio meshed node receives the RREP message 1100, the source multi-radio meshed node creates or updates the route entry for the destination node. The peer route setup is completed, and it can be used to forward the following data traffic to and from the destination node.

Route Maintenance

Route Error (RERR) mechanism is the major route maintenance mechanism to report the link/route weakness and/or failure. The RERR message generation, distribution and process are functionally the same as the ones defined in the AODV protocol (RFC 3561). When the RERR is unicast to the nodes in the precursor list, it should be unicast through the proper radio interfaces recorded in the precursor list. If the RERR is broadcast to the nodes in the precursor list, it can be broadcast on radio interfaces connected to one or more precursor nodes, or be broadcast on all available interfaces. The former one creates less routing overhead.

Route Metric

In the multi-radio system, a normalized route metric to represent the quality of each radio link is important to compare those different radio links. The target of the route metric is to distribute the traffic over all the radio links uniformly according to the link quality and traffic load so that the aggregated network throughput can be maximized.

The end-to-end route metric calculated from accumulated per-hop metric along the route. Because the routing module is shared by multiple MACs and radios, the whole multi-radio system is considered as a single routing module. Receiving from one interface and forwarding to another interface in the same routing module are counted as zero route metric and zero hop count.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. In a wireless multi-hop network including a plurality of multi-radio meshed nodes each comprising a plurality of radio modules, wherein each radio module comprises an interface, a method for a particular multi-radio meshed node to discover a route to a peer multi-radio meshed node, the method comprising:
transmitting route request (RREQ) messages from each interface of a particular multi-radio meshed node; and
receiving, at a particular recipient multi-radio meshed node, at least one of the route request (RREQ) messages and generating a reverse route to the particular multi-radio meshed node by: (a) updating an existing reverse route entry for the reverse route based on the route information from the RREQ message, or (b) creating a new route entry for the reverse route based on the route information from the RREQ message if a route entry for the reverse route entry does not exist; recording a local interface MAC address from which the RREQ message is received and a sending node interface MAC address in an interface information field of the reverse route entry; and determining the sending node MAC address from a neighbor table, and recording the sending node MAC address as a next hop address in a particular node entry of the routing table.

2. A method according to claim 1, further comprising:
determining, at the particular recipient multi-radio meshed node, if the particular recipient multi-radio meshed node is the destination node of the route request (RREQ) message;
if the particular recipient multi-radio meshed node is the destination node of the route request (RREQ) message, generating at the particular recipient node a route reply (RREP) message, and transmitting the route reply (RREP) message using the local interface towards the next hop MAC interface along the reverse route to reach the particular multi-radio meshed node;
if the particular recipient multi-radio meshed node is not the destination node of the route request (RREQ) message, determining if the particular recipient multi-radio meshed node has another route to the destination node of the route request (RREQ) message; and
if the particular recipient multi-radio meshed node has another route to the destination node of the route request (RREQ) message, generating at the particular recipient node the route reply (RREP) message, and transmitting the route reply (RREP) message using the local interface towards the next hop MAC interface along the reverse route to reach the particular multi-radio meshed node; and
if the particular recipient multi-radio meshed node does not have another route to the destination node of the route request (RREQ) message, updating the route request (RREQ) message and retransmitting the updated route request (RREQ) message over each of the interfaces of the particular recipient multi-radio meshed node.

3. A method according to claim 2, further comprising:
upon receiving the route reply (RREP) message, generating a forward route entry to the destination node at the at least one intermediate multi-radio meshed node;
recording, at the at least one intermediate multi-radio meshed node, a local interface MAC address of the particular recipient multi-radio meshed node from which the route reply (RREP) message is received, and a the sending interface MAC address of the sending multi-radio meshed node in the next hop interface information field in a route table entry for the destination node;
determining, at the at least one intermediate multi-radio meshed node, a MAC address of the sending multi-radio meshed node by which the route reply (RREQ) message is transmitted from a neighbor table of the at one intermediate multi-radio meshed node;
updating the route table by recording the node MAC address of the sending multi-radio meshed node as the next hop address in a route table entry for the destination node;
determining, from the route table of the at least one intermediate multi-radio meshed node, the next hop interface MAC address and the local radio interface MAC address leading to the particular multi-radio meshed node identified by the originator MAC address in the route reply (RREP) message; and
forwarding the route reply (RREP) message towards the particular multi-radio meshed node identified by the originator MAC address in the route reply (RREP) message.

4. A method according to claim 3, further comprising:
receiving, at the particular multi-radio meshed node, the route reply (RREP) message, wherein a peer-to-peer route is established when the particular multi-radio meshed node receives the RREP message and can be used to forward traffic to and from the destination node; and
updating a route entry for the destination node at the particular multi-radio meshed node.

5. A wireless multi-hop network, comprising:
a plurality of multi-radio meshed nodes each comprising a plurality of radio modules, wherein each radio module comprises an interface;
a particular multi-radio meshed node seeking to discover a route to a peer multi-radio meshed node, wherein the particular multi-radio meshed node comprises a plurality of first radio modules each comprising a particular interface which transmits a particular route request (RREQ) message; and
a particular recipient multi-radio meshed node which receives at least one of the route request (RREQ) messages and generates a reverse route to the particular multi-radio meshed node.

6. A network according to claim 5, wherein the particular recipient multi-radio meshed node generates the reverse route to the particular multi-radio meshed node by:
performing at least one of: (a) updating an existing reverse route entry for the reverse route based on the route information from the RREQ message, and (b) creating a new route entry for the reverse route based on the route information from the RREQ message if a route entry for the reverse route entry does not exist;
recording a local interface MAC address from which the RREQ message is received and a sending node interface MAC address in an interface information field of the reverse route entry; and
determining the sending node MAC address from a neighbor table, and recording the sending node MAC address as a next hop address in a particular node entry of the routing table.

7. A network according to claim 6, wherein the particular recipient multi-radio meshed node is designed to:
determine if the particular recipient multi-radio meshed node is the destination node of the route request (RREQ) message, or has a fresh route to the destination node of the route request (RREQ) message; and
generate a route reply (RREP) message if the particular recipient multi-radio meshed node: is the destination node of the route request (RREQ) message, or has the fresh route to the destination node of the route request (RREQ) message; and
transmit the route reply (RREP) message using the local interface towards the next hop MAC interface along the reverse route to reach the particular interface of the particular multi-radio meshed node.

8. A network according to claim 7, wherein the at least one intermediate node which receives the route reply (RREP) message updates a forward route by generating a forward route entry to the destination node at the at least one intermediate multi-radio meshed node.

9. A network according to claim 8, wherein the particular multi-radio meshed node is designed to receive the route reply (RREP) message, wherein a peer-to-peer route is established when the particular multi-radio meshed node receives the RREP message and is usable to forward traffic to and from the destination node.
